(19) United States
(12) Patent Application Publication
(10) Pub. No.: US 2022/0203510 A1
(43) Pub. Date: Jun. 30, 2022

(54) SPRING DECOMPRESSION DEVICE AND RELATED SYSTEMS AND METHODS

(71) Applicant: Premier Fabrication & Powder Coating, Inc., Boone, IA (US)

(72) Inventor: Joe McBirnie, Boone, IA (US)

(21) Appl. No.: 17/564,662

(22) Filed: Dec. 29, 2021

Related U.S. Application Data
(60) Provisional application No. 63/131,980, filed on Dec. 30, 2020.

(51) Int. Cl. B25B 27/30; B25B 27/00

(52) U.S. Cl. CPC B25B 27/304; B25B 27/0035

(57) ABSTRACT

A clamping device including an elongate backbone, a first clamp end slidably engaged with the elongate backbone, a second clamp end slidably engaged with the elongate backbone, and a handle operatively engaged with the first clamp end, wherein upon actuation of the handle the first clamp end is urged toward the second clamp end decreasing the distance between the first clamp end and the second clamp end. The clamping device configured to operate with automotive suspension springs, spring slider, and shocks such that upon use of the clamping device spring pressure is unloaded from a vehicle, spring slider, and/or shock and is transferred to the clamping device such that suspension adjustments and/or spring replacement can be effectuated quickly and safely.

### CROSS-REFERENCE TO RELATED APPLICATION(S)

This application claims the benefit under 35 U.S.C. § 119(e) to U.S. Provisional Application No. 63/131,980, filed Dec. 30, 2020, and entitled “Spring Decompression Device and Related Systems and Methods,” which is hereby incorporated herein by reference in its entirety for all purposes.

### TECHNICAL FIELD

The disclosure relates to spring compression and decompression devices, and more particularly spring compression/decompression devices for use in automobiles and specifically race cars.

### BACKGROUND

Prior know methods for adjusting pressure on springs installed on race cars, particularly springs installed on dirt modified race cars, require manually turning a nut on a spring slider. This type of adjustment can be difficult and time consuming, which is detrimental to quick changes that may be desired in shop and a race type environment.

There is a need in the art for improved devices, systems, and methods for removing springs and adjusting spring pressure.

### BRIEF SUMMARY

Disclosed herein are various devices for adjusting, loading, and unloading spring pressure. Various implementations are for use with race cars and particularly dirt modified race cars. In certain implementations, the clamping device is placed above and below the spring and around the spring slider such that in the clamped position the spring pressure is released from the spring slider and is held by the clamping device. With the spring pressure on the clamping device, the spring can be quickly and easily unmounted from the car for replacement and/or adjustments may be made to the spring/suspension system of the car.

Example 1 relates to a clamping device comprising an elongate backbone, a first clamp end slidably engaged with the elongate backbone, a second clamp end engaged with the elongate backbone, and a handle operatively engaged with the first clamp end, wherein upon actuation of the handle the first clamp end is urged toward the second clamp end decreasing a distance between the first clamp end and the second clamp end.

In Example 2, the clamping device of Example 1, wherein the first clamp end and the second clamp end are shaped to be engaged with an automotive suspension spring.

In Example 3, the clamping device of any of Examples 1-2, wherein the first clamp end and the second clamp end are both approximately circular with an opening on a side substantially opposite the elongate backbone.

In Example 4, the clamping device of any of Examples 1-3, wherein the automotive suspension spring is a 5-inch outer diameter spring.

In Example 5, the clamping device of any of Examples 1-4, wherein the automotive suspension spring is a 2.5-inch outer diameter spring.

In Example 6, the clamping device of any of Examples 1-5, wherein the automotive suspension spring is compressed between the first clamp end and second clamp end upon actuation of the handle.

In Example 7, the clamping device of any of Examples 1-6, wherein the elongate backbone comprises are series of openings defined therein for receiving a pin, wherein the openings and pin are configured to adjust the relative spacing of the first clamp end and second clamp end along the elongate backbone.

Example 8 relates to a spring compression system comprising a clamping device comprising a first clamp end, a second clamp end, an elongate backbone wherein the first clamp end and second clamp end are disposed along the elongate backbone, and a handle operatively engaged with the first clamp end, wherein upon actuation of the handle the first clamp end is urged from a first position a first distance from the second clamp end to a second position a second distance from the second clamp end and wherein the first distance is greater than the second distance.

In Example 9, the spring compression system of Example 8, wherein the first clamp end is generally horseshoe shaped comprising a first side opening and defining a lumen.

In Example 10, the spring compression system of any of Examples 8-9, wherein the second clamp end is generally horseshoe shaped comprising a second side opening and further defining the lumen.

In Example 11, the spring compression system of any of Examples 8-10, wherein the first side opening and second side opening are shaped such that a spring slider or shock can fit through the first side opening and second side opening and be disposed within the lumen.

In Example 12, the spring compression system of any of Examples 8-11, wherein the first clamp end comprises a first contact surface configured to be engaged with a first end of a spring, and wherein the second clamp end comprises a second contact surface configured to be engaged with the second end of the spring.

In Example 13, the spring compression system of any of Examples 8-12, wherein when the clamping device is in the second position the spring is compressed between the first contact surface and the second contact surface and spring load is held by the clamping device.

In Example 14, the spring compression system of any of Examples 8-13, wherein in the second position the clamping device allows for removal of a spring from a car.

In Example 15, the spring compression system of any of Examples 8-14, wherein in the second position the clamping device allows for adjustments to be made to the tension of the spring or suspension of a car.

In Example 16, the spring compression system of any of Examples 8-15, wherein the clamping device further comprises an adjustment system configured to change the relative distance between the first clamp end and second clamp end along the elongate backbone.

In Example 17, the spring compression system of any of Examples 8-16, wherein the adjustment system comprises a plurality of openings within the elongate backbone configured to accept a pin, wherein the pin may be located in any of the plurality of openings and such that the second clamp end is held in place along the elongate backbone by the pin.

In Example 18, the spring compression system of any of Examples 8-17, wherein the relative distance between the first clamp end and second clamp end is changed based on length of a spring to be compressed.

In Example 19, the spring compression system of any of Examples 8-18, wherein the relative distance between the first clamp end and second clamp end is changed based on desired compression loading of a spring.

Example 20 relates to a method of compressing a spring on a car comprising placing a clamping device around a spring slider or suspension, wherein the clamping device comprises a first clamp end comprising a first contact surface, a second clamp end comprising a second contact surface, an elongate backbone wherein the first clamp end and second clamp end are slidably engaged with elongate backbone, and a handle configured to urge the first clamp end centrally along the elongate backbone; placing the first contact surface in contact with a first end of a spring; placing a second contact surface in contact with a second end of a spring; and actuating the handle to urge the first clamp end centrally toward the second clamp end compressing the spring and unloading pressure from the spring slider or suspension.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a side view of the device in use, according to one implementation.

FIG. 2 is a side view of the device in use, according to one implementation.

FIG. 3 is a perspective view of the device in a clamped position, according to one implementation.

FIG. 4 is a perspective view of the device of FIG. 3 in the unclamped or released position, according to one implementation.

### DETAILED DESCRIPTION

Various implementations disclosed and contemplated herein relate to devices for adjusting, unloading, and loading spring pressure on a spring slider and/or other suspension component(s) of an automobile. In further implementations, the device allows for quick and safe removal of a spring and installation of a different spring.

In certain implementations, the device is used in connection with spring sliders on race cars, and more specifically dirt modified race cars, although other applications would be appreciated. Various adjustments to and/or the replacement of the spring(s) may be required or desired for various track and other usage conditions, as would be understood. The various implementations allow for adjustments to be made to the car suspension quickly, which is desirable in a race environment and also in a shop to maximize efficiency.

As would be understood by those of skill in the art, springs associated with the suspension of a car, and particularly race cars are under pressure which can cause adjusting them to be difficult, time consuming, and in certain circumstances dangerous. In various of the implementations disclosed and contemplated herein, a clamping device is configured to unload pressure from such a spring while the spring is attached to or engaged with a car. In various of these implementations, the device can be used to unload spring pressure to allow for quick adjustments to be made to the spring, spring slider, shock, and/or suspension.

In further implementations, the device may be used to remove a spring from the car, store the spring under pressure, and/or install a spring under the desired pressure.

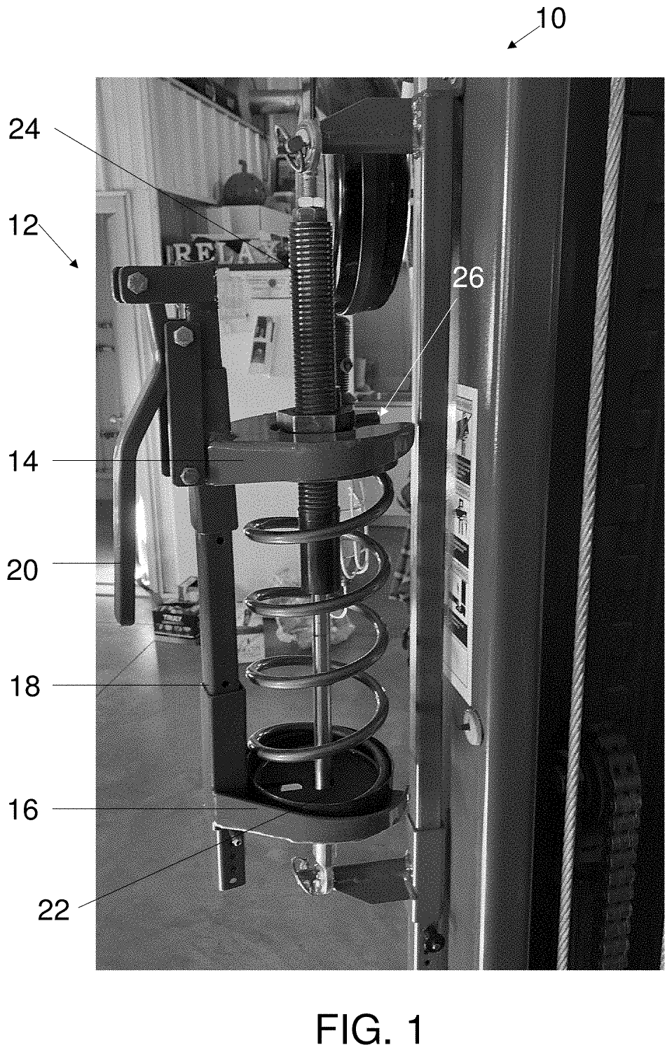

Turning to the figures in more detail, discussed herein is a system 10 for unloading spring pressure. In various implementations, a spring compression system 10 includes a clamping device 12, shown in FIGS. 1-4. In certain implementations, the device 12 includes a first clamp end 14 and a second clamp end 16 connected via an elongate backbone 18. In certain implementations, the first clamp end 14 and/or second clamp end 16 are slidably engaged with the elongate backbone 18.

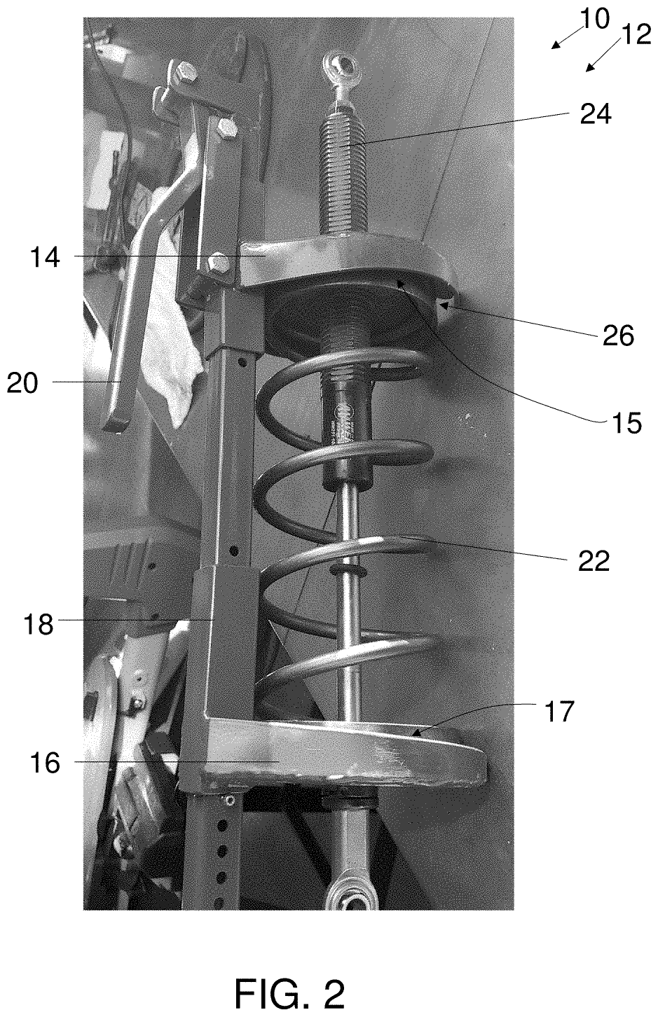

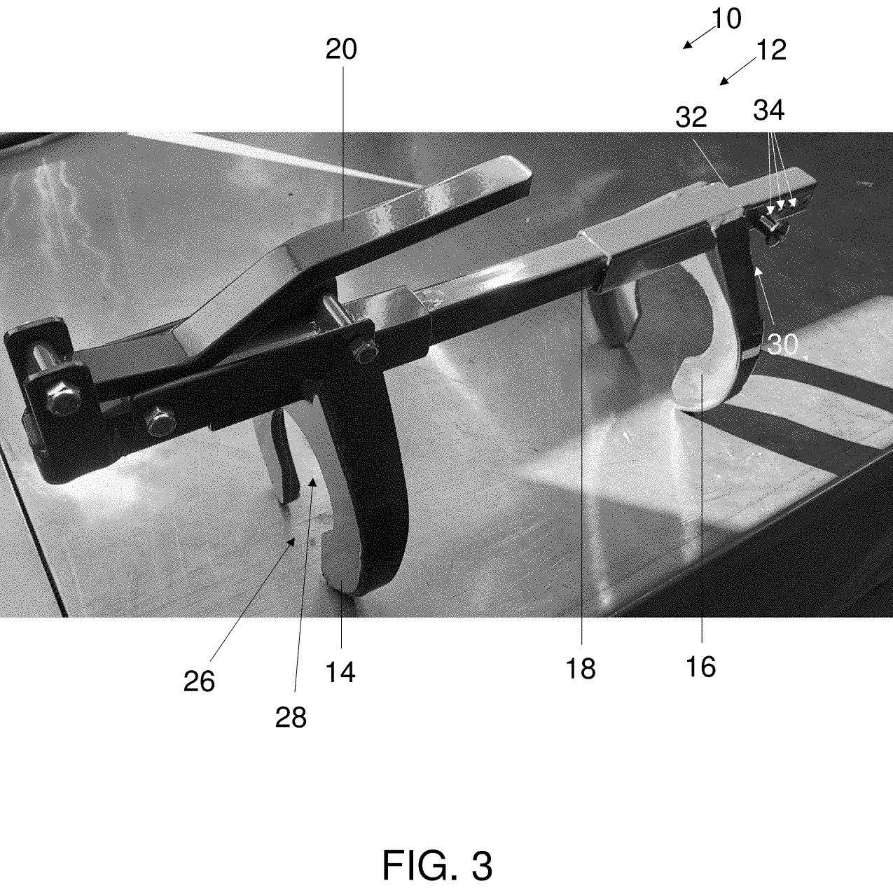

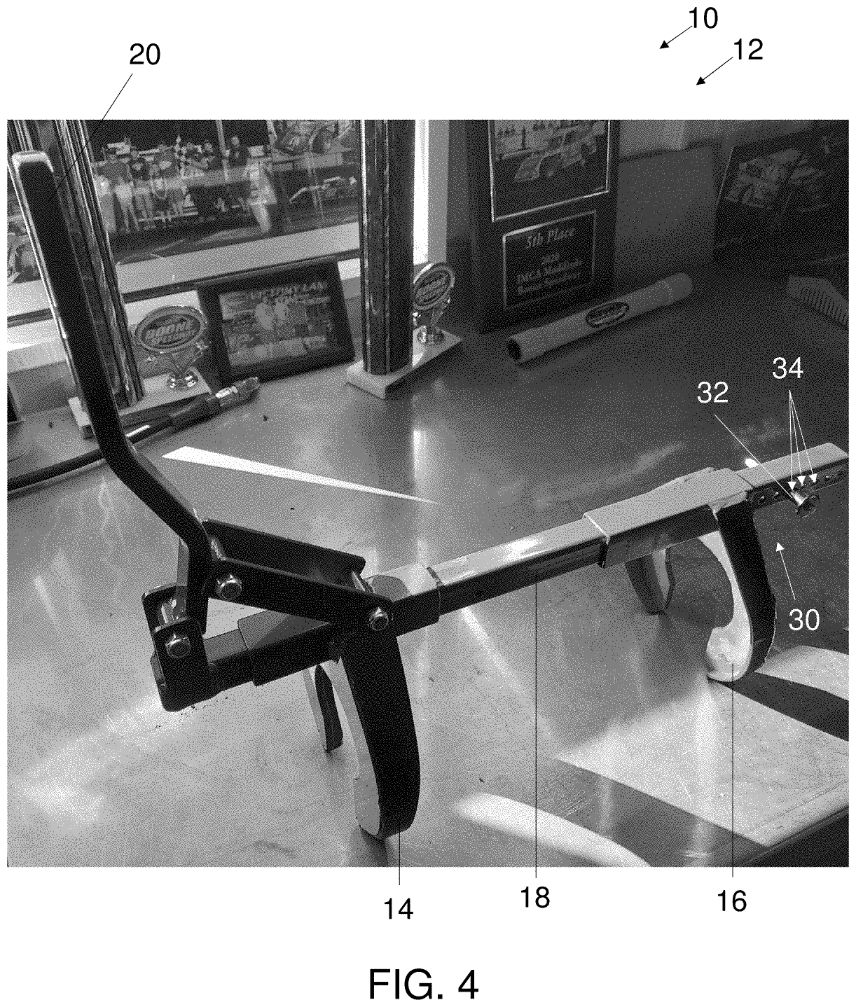

In various implementations, the first clamp end 14 and second clamp end 16 are generally horseshoe shaped, or other appropriate shape, with a side opening 26 and defining a lumen 28 (shown best in FIGS. 3 and 4). That is, in certain implementations, the first and second clamp ends 14, 16 may be generally circular with an open portion 26. As seen in FIGS. 1 and 2, in certain implementations, the side opening 26 is at least large enough that a spring slider 24 and/or shock may fit through the side opening 26 such that the spring slider 24 or shock can be centrally disposed in the lumen 28 (shown best in FIGS. 3 and 4).

Continuing with FIGS. 1 and 2, in various implementations, the first clamp end 14 and second clamp end 16 are shaped to be engaged with the ends of the spring 22. In these and other implementations the first clamp end 14 includes a contact surface 15 configured to be engaged with a first end of a spring 22. The second clamp end 16 may also include a contact surface 17 to be engaged with the second end of a spring 22,

In certain implementations, the first clamp end 14 and second clamp end 16 are sized to be used in conjunction with 5-inch outer diameter springs, 2.5-inch outer diameter springs, or any other spring size as would be appreciated by those of skill in the art.

Further, in certain implementations, the device 12 includes a handle 20 operatively engaged with the first clamp end 14 and/or second clamp end 16. In various implementations, upon actuation of the handle 20 one or more of the clamp ends 14, 16 are urged centrally. That is, one or more of the clamp ends 14, 16 are urged towards each other decreasing the distance between the clamp ends 14, 16. In use, upon actuation, when the spring 22 and spring slider 24 are disposed within the device 12, the spring 22 compresses between the first and second clamp ends 14, 16 such that the spring's load is held by the device 12 and is taken off of the spring slider 24 or other suspension component as would be appreciated.

FIGS. 3 and 4 show the actuation of the handle 20 and the corresponding movement of components of the device 12. In the compressed or loaded position (shown in FIG. 3) the first clamp end 14 and second clamp end 16 are disposed at a first distance apart. In the decompressed or unloaded position (shown in FIG. 4) the first clamp end 14 and second damp end 16 are disposed at a second distance apart where the second distance is greater than the first distance.

In various implementations, the device 12 includes a lock and pin system 30 at one end of the device, shown in FIGS. 3 and 4. In certain implementations, the lock and pin system 30 allows for adjustment of the position of the second clamp end 16 along the elongate backbone 18. In these implementations, the pin 32 acts to prevent the second damp end 16 from moving past the pin 32.

In certain implementations, one or more openings 34 are provided in the elongate backbone 13 such that the location of the pin 32 can be moved, according to the device's 12 use. As would be appreciated the pin 32 may be moved to a more central opening 34 such that the distance between the first damp end 14 and the second clamp end 16 is decreased, or vice versa. Such an adjustment can be made to correspondingly increase or decrease the amount of load on the spring 22 when compressed by the device 12. In further implementations, the pin 32 location can be adjusted based on the length of the spring 22 to provide appropriate loading and unloading of the spring 22.

Various alternative mechanisms for adjusting the relative positioning of the first and second clamp ends 14, 16 along the elongate backbone 18 are possible and would be appreciated by those of skill in the art.

In certain implementations, the device 12 is formed of steel, aluminum, or other appropriate material as appreciated by those of skill in the art. In one specific implementation, the elongate backbone 18 is formed from 1-inch steel tubing, the connection points between the elongate backbone 18 and the first clamp end 14 and second clamp end 16 are formed of 1.5-inch steel tubing, and the other components are be formed from steel sheeting. Various alternative manufacturing components and processes may be used as would be appreciated.

Although the disclosure has been described with references to various embodiments, persons skilled in the art will recognized that changes may be made in form and detail without departing from the spirit and scope of this disclosure.

What is claimed is:

1. A clamping device comprising:
(a) an elongate backbone;
(b) a first clamp end slidably engaged with the elongate backbone;
(c) a second clamp end engaged with the elongate backbone; and
(d) a handle operatively engaged with the first clamp end,
wherein upon actuation of the handle the first clamp end is urged toward the second clamp end decreasing a distance between the first clamp end and the second clamp end.

2. The clamping device of claim 1, wherein the first clamp end and the second clamp end are shaped to be engaged with an automotive suspension spring.

3. The clamping device of claim 2, wherein the first clamp end and the second clamp end are both approximately circular with an opening on a side substantially opposite the elongate backbone.

4. The clamping device of claim 2, wherein the automotive suspension spring is a 5-inch outer diameter spring.

5. The clamping device of claim 2, wherein the automotive suspension spring is a 2.5-inch outer diameter spring.

6. The clamping device of claim 2, wherein the automotive suspension spring is compressed between the first clamp end and second clamp end upon actuation of the handle.

7. The clamping device of claim 1, wherein the elongate backbone comprises are series of openings defined therein for receiving a pin, wherein the openings and pin are configured to adjust the relative spacing of the first clamp end and second clamp end along the elongate backbone.

8. A spring compression system, comprising a clamping device comprising:
(a) a first clamp end;
(b) a second clamp end;
(c) an elongate backbone, wherein the first clamp end and second clamp end are disposed along the elongate backbone; and
(d) a handle operatively engaged with the first clamp end,
wherein upon actuation of the handle the first clamp end is urged from a first position a first distance from the second clamp end to a second position a second distance from the second clamp end and wherein the first distance is greater than the second distance.

9. The spring compression system of claim 8, wherein the first clamp end is generally horseshoe shaped comprising a first side opening and defining a lumen.

10. The spring compression system of claim 9, wherein the second clamp end is generally horseshoe shaped comprising a second side opening and further defining the lumen.

11. The spring compression system of claim 10, wherein the first side opening and second side opening are shaped such that a spring slider or shock can fit through the first side opening and second side opening and be disposed within the lumen.

12. The spring compression system of claim 8, wherein the first clamp end comprises a first contact surface configured to be engaged with a first end of a spring, and wherein the second clamp end comprises a second contact surface configured to be engaged with the second end of the spring.

13. The spring compression system of claim 12, wherein when the clamping device is in the second position the spring is compressed between the first contact surface and the second contact surface and spring load is held by the clamping device.

14. The spring compression system of claim 8, wherein in the second position the clamping device allows for removal of a spring from a car.

15. The spring compression system of claim 8, wherein in the second position the clamping device allows for adjustments to be made to the tension of the spring or suspension of a car.

16. The spring compression system of claim 8, wherein the clamping device further comprises an adjustment system configured to change the relative distance between the first clamp end and second clamp end along the elongate backbone.

17. The spring compression system of claim 16, wherein the adjustment system comprises a plurality of openings within the elongate backbone configured to accept a pin, wherein the pin may be located in any of the plurality of openings and such that the second clamp end is held in place along the elongate backbone by the pin.

18. The spring compression system of claim 16, wherein the relative distance between the first clamp end and second clamp end is changed based on length of a spring to be compressed.

19. The spring compression system of claim 16, wherein the relative distance between the first clamp end and second clamp end is changed based on desired compression loading of a spring.

20. A method of compressing a spring on a car comprising:
placing a clamping device around a spring slider or suspension, wherein the clamping device comprises:
a first clamp end comprising a first contact surface;
a second clamp end comprising a second contact surface;
an elongate backbone wherein the first clamp end and second clamp end are slidably engaged with elongate backbone; and
a handle configured to urge the first clamp end centrally along the elongate backbone;
placing the first contact surface in contact with a first end of a spring;
placing a second contact surface in contact with a second end of a spring; and
actuating the handle to urge the first clamp end centrally toward the second clamp end compressing the spring and unloading pressure from the spring slider or suspension.
